(19) United States
(12) Patent Application Publication
(10) Pub. No.: US 2007/0256307 A1
(43) Pub. Date: Nov. 8, 2007

(54) METHOD AND DEVICE FOR DISPENSING ARTICLES FROM BLISTER PACKS

(76) Inventor: Andre Mann, Meredith, NH (US)

Correspondence Address: BOURQUE & ASSOCIATES;INTELLECTUAL PROPERTY ATTORNEYS, P.A., 835 HANOVER STREET, SUITE 301, MANCHESTER, NH, 03104, US

(21) Appl. No.: 11/744,516

(22) Filed: May 4, 2007

Related U.S. Application Data
(60) Provisional application No. 60/798,478, filed on May 8, 2006.

(51) Int. Cl. B26B 17/00; B26B 13/00

(52) U.S. Cl. 30/186; 30/175; 30/191; 30/253

(57) ABSTRACT

A cutter designed to release and remove objects such as medication pills and the like from an encapsulated packaging such as a blister pack. The cutter includes at least one blade which is advanced proximate the bottom region of the object and which cuts through the packaging and releases the object. In the preferred embodiment, the cutter included two blades each coupled to a shaft. The two shafts are connected together proximate an end opposite the cutter end and pivot to allow one handed operation.

### CROSS-REFERENCE TO RELATED APPLICATIONS

This application is related to and claims priority from U.S. Provisional Application No. 60/798,478 filed on May 8, 2006 entitled Method and Device for Dispensing Articles From Blister Packs, which is incorporated fully herein by reference.

### TECHNICAL FIELD

The present invention relates to medications, such as pills, packaged in sealed wells often referred to as “blister packs” and more particularly, relates to a method and device for easily dispensing articles from such blister packs.

### BACKGROUND INFORMATION

Blister packaging is widely used to retain both over-the-counter (OTC) and some prescription medication and vitamins in plastic and aluminum containers until consumption. Most of these blister packs require individual release of one or two tablets or capsules at a time.

The prevailing way to release tablets and capsules from blister packaging is to push the contents through a foil layer that can rupture thereby releasing the medication. See for example U.S. Pat. No. 6,206,233 (blister packaging pill ejection method and apparatus); U.S. Pat. No. 6,557,740 (device for removing a pill from its package); U.S. Pat. No. 5,464,118 (apparatus for removing solid medications from blister packs); U.S. Pat. No. 5,791,513 (medication dispensing aid); U.S. Pat. No. 5,853,101 (blister pack opener); and U.S. Pat. No. 5,722,563 (tool for removing pills and the like from blister packs) as examples of technology designed to rupture the blister foil (bottom) by means of a sharp object and/or pressure exerted on the (plastic) pill well (top), using the contained medication as the “prong” to rupture the foil. All these devices are in essence attempts to allow and facilitate the consumer's push on the pill, and release it from its container though the foil.

For most single layer aluminum foils, this downward pressure based approach is a replacement of the human finger that may have utility for some patients and consumers. With increasing strength of the foil, however, the push method becomes a hazard with great potential to crush the pill in rather than release it from its container. Increasingly, blister tops have become multi-layered packages of paper and aluminum-foil that need to be peeled open rather than pushed through. Since 2002, such child-proof blisters have been mandated by the FDA for prescription products that are switched to Over-The-Counter (OTC) status. From elderly consumers with a cold to arthritic and otherwise physically or visually impaired patients with heartburn or a headache, these blister packages are hard to open and a constant source of frustration for many individuals.

### SUMMARY OF THE INVENTION

The “well cutter”, as the present invention may often be referred to herein, is a novel device and method designed to easily open blister packaging containing medications, vitamins, and other articles for individual use. It is especially suited for opening multi-layered medication blisters whether or not such packaging resists finger pressure and/or needs to be peeled open. Rather than pushing the contents of the container (i.e. the “well”) through foil, the well cutter is designed to approach the problem from the other side by “cutting off” the cap of the well at the base of the object to be removed.

It is important to note that the present invention is not intended to be limited to a system or method which must satisfy one or more of any stated objects or features of the invention. It is also important to note that the present invention is not limited to the preferred, exemplary, or primary embodiment(s) described herein. Modifications and substitutions by one of ordinary skill in the art are considered to be within the scope of the present invention, which is not to be limited except by the allowed claims and their legal equivalents.

### BRIEF DESCRIPTION OF THE DRAWINGS

### These and other features and advantages of the present invention will be better understood by reading the following detailed description, taken together with the drawings wherein:

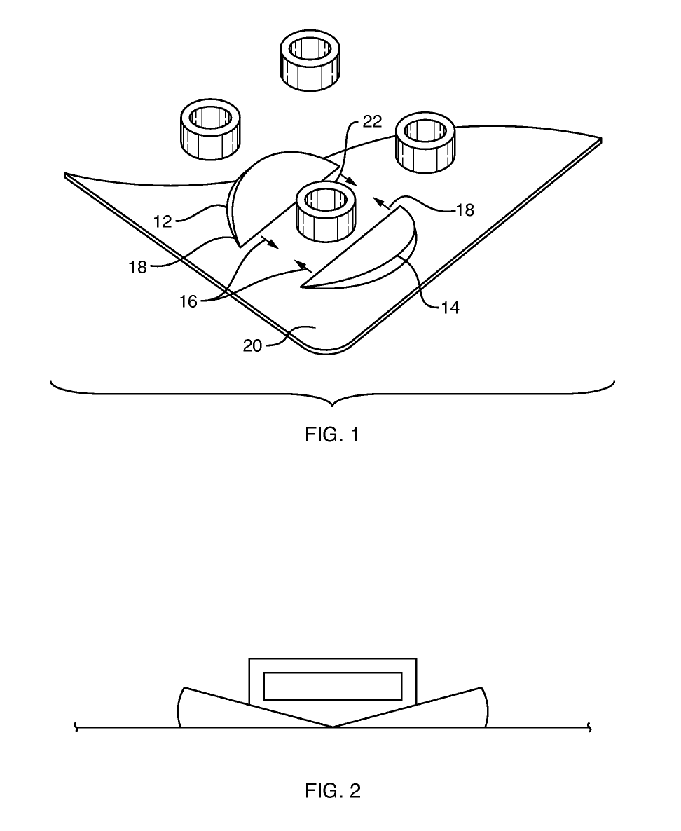

FIG. 1 is a schematic diagram Illustrating the operation of two cutter blades to release an encapsulated object in accordance with the present invention;

FIG. 2 is a schematic diagram illustrating a cross-sectional view of two cutter blades cutting through an encapsulated packaging for an object in accordance with the present invention;

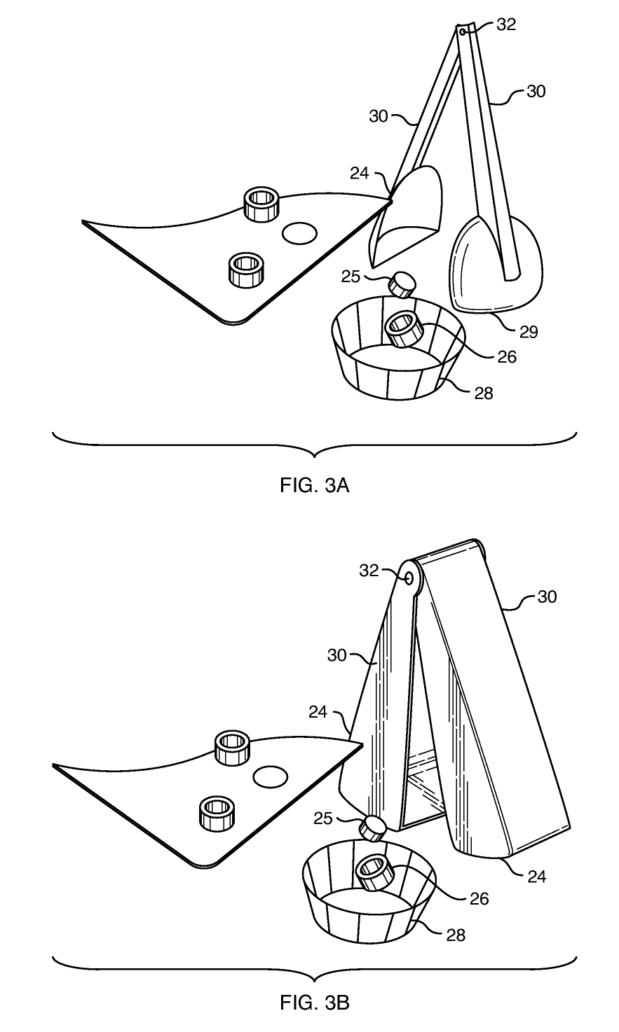

FIGS. 3A and 3B are schematic diagrams illustrating receiver regions located proximate the cutter blades of a cutter in accordance with the present teachings;

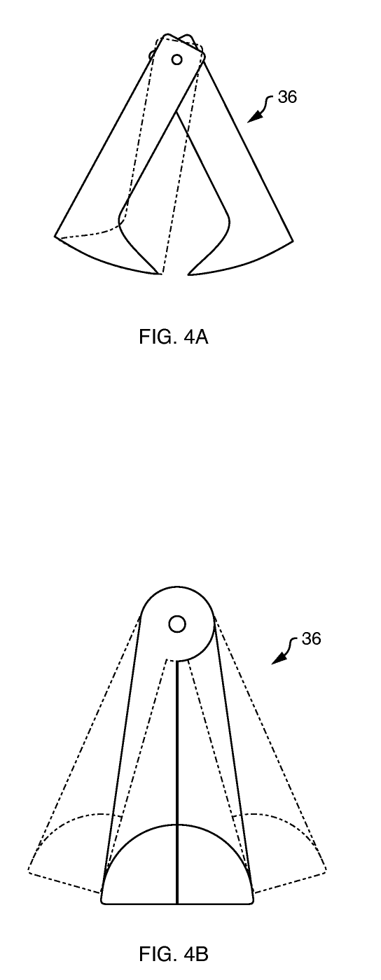

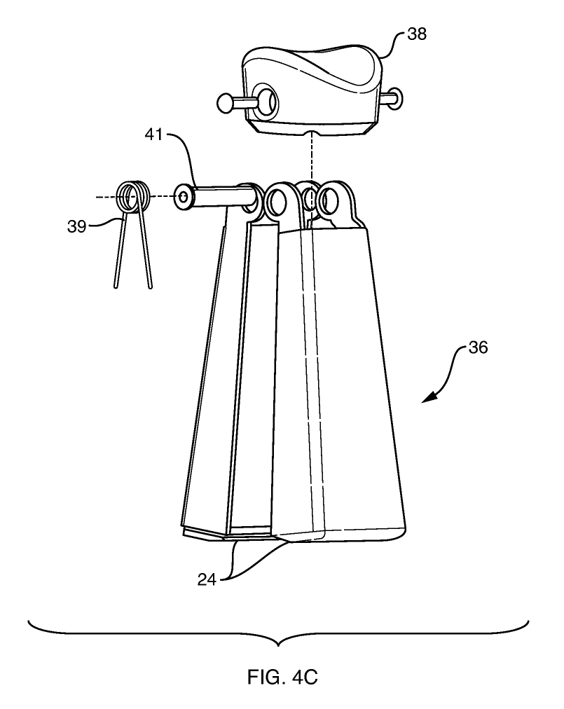

FIGS. 4A, 4B and 4C are schematic diagrams illustrating one construction of the cutter in accordance with the present invention;

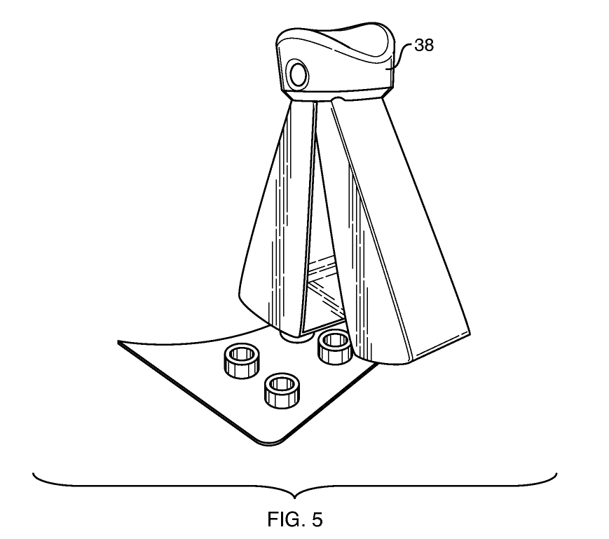

FIG. 5 is a schematic diagram illustrating a cutter with a cap and release hole in accordance with the teachings of the present invention;

FIG. 6 is a schematic diagram illustrating a cap proximate the pivoted end of a cutter in accordance with the present invention;

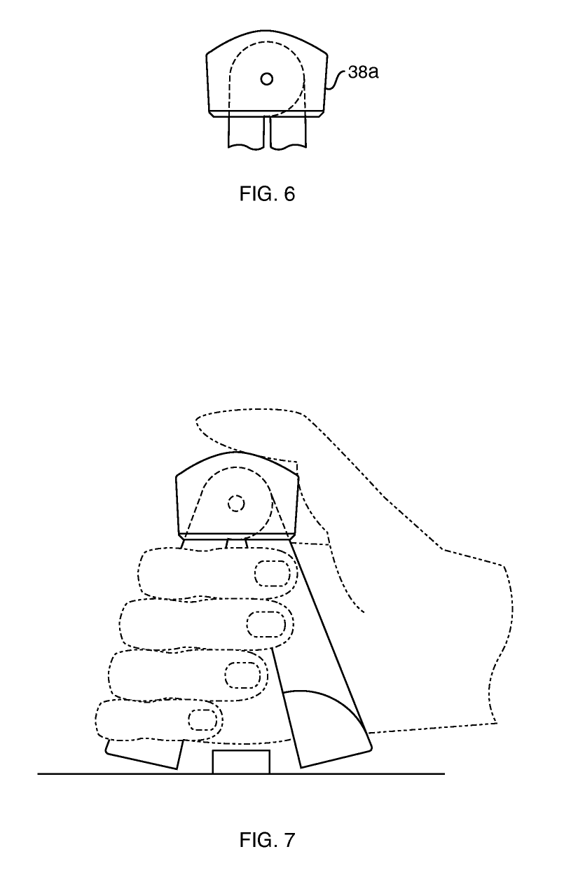

FIG. 7 is a schematic diagram illustrating a users grip in utilizing a cutter in accordance with the teachings of the present invention;

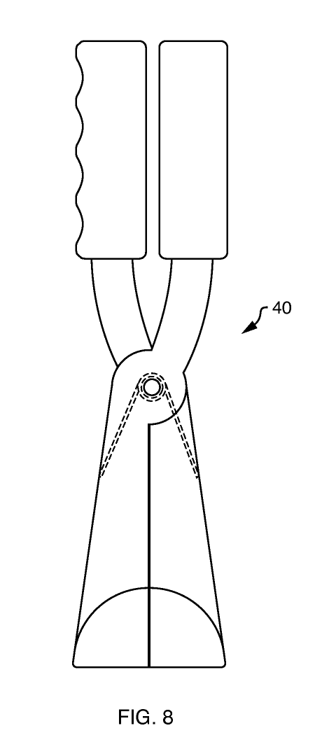

FIG. 8 is a schematic diagram of a cutter including a pair of handles in accordance with the teachings of the present invention;

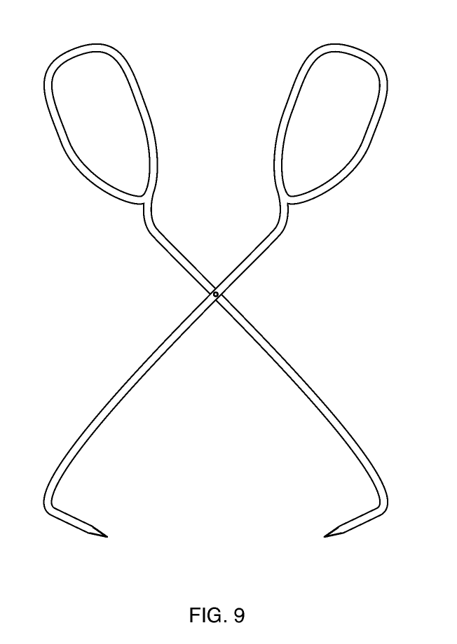

FIG. 9 is a schematic diagram of a scissor type cutter in accordance with the present invention;

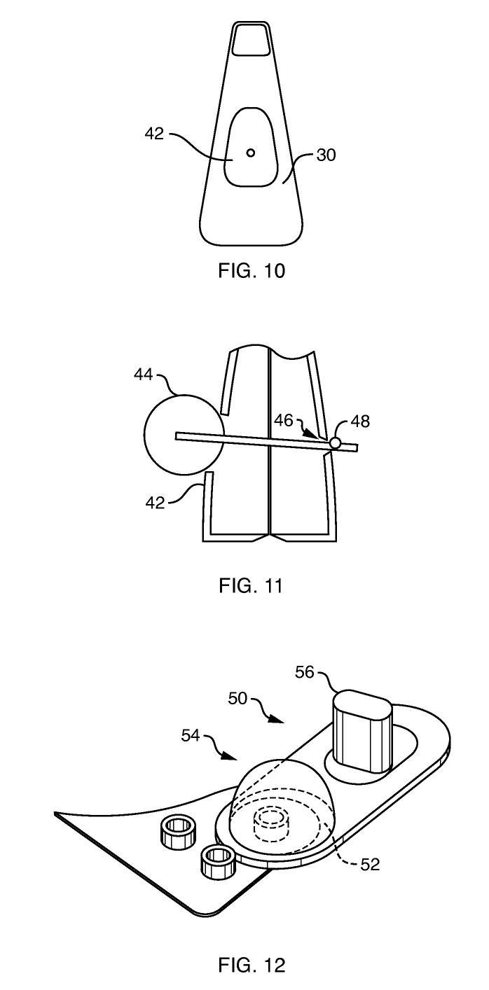

FIG. 10 is a schematic diagram illustrating an access hole in one of the shafts of the cutter in accordance with one feature of the present invention;

FIG. 11 is a schematic diagram illustrating a locking pin in accordance with another feature of the present invention;

FIG. 12 is a schematic diagram illustrating a single blade cutter in accordance with the teachings of the present invention;

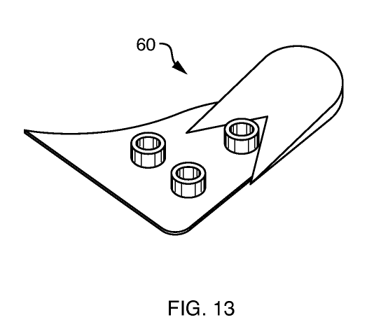

FIG. 13 is a schematic diagram illustrating a single blade, the V-shaped cutter in accordance with the present invention; and

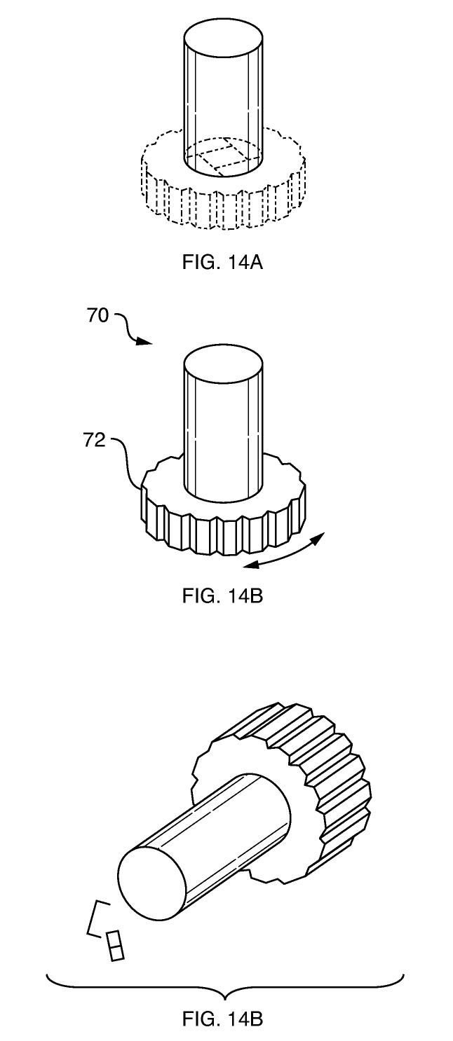

FIGS. 14A-14C are schematic diagrams illustrating a concentric ring cutter in accordance with a further embodiment of the present invention.

### DESCRIPTION OF THE PREFERRED EMBODIMENTS

In one embodiment, two identical, opposite cutting blades 12, 14, FIG. 1, coupled to cutter shafts (not shown) open and close with straight, parallel cutting edges. While closing in the direction indicated generally by arrows 16, the cutting edges 18 slide over the blister pack surface 20 under the through the pill well 22 to cut the pill well 22 at the lowest point possible where it attaches to the blister pack surface 20 and slide under, rather than compress, the tablet or capsule(s) contained within the pill well 22. When closed, the cutting blades form a solid surface that functions as the bottom of a receptacle, FIG. 2.

Two, identical, opposing “cup”-like receptacles 24, FIGS. 3A and 3B may be molded on top of the cutting blades 12, 14 to create a “container” that captures the blister pack cap 25 and contents of the well 26 (i.e. the pill or other medication or well contents) when the cutting blades 12, 14 close. The contents 26 with or without the cap 25 can then be either placed in the user's hand or in a container such as a cup 28. The receptacles 24 can be either round or rectangular, and take up part or all of the length of the two shafts 30 that connect at a pivot point 32. Upon opening, the receptacles 24 separate and release the cap 25 and contents 26 into a medicine cup 28 or the user's hand.

The “two blade” well cutter according to one embodiment of the present invention can be manufactured much like a staple remover 36, FIGS. 4A-4C, to exert the necessary pressure to cut the well. A spring 39 at or near the pivot point around pin 41 keeps the shafts 24 apart as is provided for a staple remover for example.

The blades 12, 14, cup like receptacles 24 and shafts 30 of the well cutter according to the present invention are identical and close against each other, requiring a slight offset of the shafts just below the pivot point due to the thickness of the shaft, as shown in FIG. 4.

Most embodiments of the well cutter according to the present invention typically include a “cap” 38, FIGS. 4C, 5 and 6, that allows the user to put downward pressure on the device to keep it down on the blister surface. The cap 38 is connected to the shafts 30 by the same pivot pin 41 that keeps the shafts together.

The well cutter according to the present invention is sized to fit well in an adult hand. Typical preferred measurements of the two-blade well cutter of the present invention based on measurements of various OTC medication blisters, are as follows:
a. Wall thickness of the Receptacle, ⅛ inch± 1/16 inch;
b. Inside dimensions of Receptacle are approximately
Width: 1⅛ inch
Depth: ⅝ inch
Wall height before tapering: ½ inch;
c. Cutter (bottom of Receptacle) blade width
1⅛ inch (inside measure of receptacle)
1⅜ inch (outside dimension);
d. Minimum opening (separation of cutting edges) is 1⅜ inch;
e. Exterior, sharpened surfaces of the cutting blades should be flat on the surface of the blister at an opening of 1⅛ inch;

In general, longer shafts are better to enhance leverage and to minimize the cutting angle. Minimum useful length of the shaft is approximately 2½ inches. At an opening of 1⅛ inch, a shaft of 2½ inch provides little leverage and requires a rather steep cutting angle of 13-14°. Maximum length is in the order of 5½ inch. This length requires a cutting angle of 5-6°. Any longer, and the cutting angle becomes too low for the cutter blades.

A shaft length of approximately 3½ inch is considered optimal for a “staple remover” type model as this size fits well in an adult hand and leaves some room on the top for the “cap” 38 that allows the user to put pressure on the device to keep it down on the blister surface, see FIG. 7. This length requires a cutting angle of 10-11°.

A shaft length of approximately 4½ inch is believed to be optimal for a scissor type model cutter 40, FIG. 8. This size has the most leverage and requires an acceptable cutting angle of 8-9°. Like the power grip design, the scissor design requires a slight offset of the well-cutter shafts below the pivot point to allow complete closure. While a pair of scissors has cutting edges that gradually slide past each other upon closing, the cutting edges of the well cutter approach each other in parallel until fully closed with the sharp edges of the cutting blades making near or full direct contact with one another.

In another similar embodiment shown in FIG. 9, a conventional “open” scissor design with well-cutter type blades attached to both arms is contemplated. The cutting principle remains the same with the cutting blades able to literally capture pills and capsules after cutting off the pill well.

The knife-like cutting edges of the well cutter of the present invention are internally oriented of to avoid scraping and “catching” of the blades on the blister surface while the integration of a dome(s) (or other shape) and cutting blade(s) into a receptacle to capture the cut-off cap and contents is contemplated by the present invention.

No different than with any pair of scissors, sharpened pliers or the like, it would be generally unwise to try removing stuck caps of pill wells by introducing a finger between the cutting blades. Accordingly, a hole 42, FIG. 10 of approximately ⅞ inch diameter in one of the shafts 30 allows a pencil, locking pin, or small finger to be used to push out any remaining cap or other material in the device.

An additional feature of the present invention includes a lock pin 44, FIG. 11, which may be inserted through the “poking hole” 42 on one shaft 30 and pushed through a narrowly fitting hole 46 in the other shaft that is tapered inside out to prevent removing the pin without depressing the lock button 48. On the “poking hole” side, a key ring of at least 1 inch diameter keeps the pin in place. The distance on the pin between the key ring hole and the lock button is approximately 1½ inch.

A well-cutting device in accordance with another embodiment of the present invention may be made like a cigar cutter 50, FIG. 12, with a straight, round, half-round, elliptical or V-shaped blade 52 and a receptacle 54 fitted on top of the outer edge of the rim around the opening. To slide the cutting blade closed, the blade will require a protrusion 56 on the same side as the receptacle, because the device will need to be placed on a flat surface, making it impossible to put a thumb or finger through the device as done when cutting a cigar.

In contrast to the centrally placed cutting edge of the cigar cutter, the sharp edge of the cutting device of the well cutter needs to be placed on the outer edge of the rim, opposite from the receptacle, requiring different rims and sliding blade edges.

A one piece device with a straight, half-round, elliptical or V-shaped cutting edge 60, FIG. 13, as a bottom region could cut the pill well low and scoop up the cap and contents when slid across the blister on a hard surface by the user is also contemplated by the present invention.

An open cylinder-shaped device 70, FIG. 14 with concentric knife blades located in the bottom region that are activated by an external, rotating ring 72 can cut off the pill-well. The closed concentric blades FIG. 14A will form a bottom for the cylindrical container. Users can remove the cap and contents of the pill-well simply by emptying the cylinder like a cup or can, FIG. 14C. This design can be made with or without a “rim” or other grip attached to the upper end of the cylinder.

The present invention is not intended to be limited to a system or method that must satisfy one or more of any stated or implied objects or features of the invention. It is also important to note that the present invention is not limited to the preferred, exemplary, or primary embodiment(s) described herein. Modifications and substitutions by one of ordinary skill in the art are considered to be within the scope of the present invention, which is not to be limited except by the allowed claims and their legal equivalents.

What is claimed is:

1. A cutter for removing an object from an encapsulated packaging, said encapsulated packaging having a generally flat, planar surface, said encapsulated object protruding upwardly from said generally flat, planar surface and enclosed in an encapsulated packaging cavity having a base region and a top region, said cutter comprising:
at least one cutter blade, configured to be placed generally against and parallel to said generally flat, planar surface of said encapsulated packaging, and configured to be advanced against and proximate one side of a base region of said encapsulated packaging cavity and advanced further through said base region, for cutting generally through said encapsulated packaging cavity thereby releasing said encapsulated object from said encapsulated packaging.

2. The cutter of claim 1, wherein said cutter includes first and second cutter blades, said first and second cutter blades operatively coupled to first and second shafts respectively, said first and second shafts having a first end proximate said cutter blade and a second end remote from said cutter blade, said first and second shafts pivotably connected proximate their respective second ends, said first and second shafts configured for movement which advances said first and second cutter blades toward one another, said first and second cutter blades configured to be placed generally against and parallel to said generally flat, planar surface of said encapsulated packaging, and further configured to be advanced against and proximate first and second sides respectively of a base region of said encapsulated packaging cavity and advanced further through said base region, for cutting generally through said encapsulated packaging cavity thereby releasing said encapsulated object from said encapsulated packaging.

3. The cutter of claim 2, further including first and second encapsulated object receptacle regions formed by and proximate to said first and second blades attached to said first and second shafts respectively, for generally receiving and holding said encapsulated object to released from said encapsulated packaging.

4. The cutter of claim 2, further including a spring disposed in said first and second shafts proximate said second end of said first and second shafts, for urging said first and second blades coupled to said first end of said first and second shaft away from one another when said cutter is not in use.

5. The cutter of claim 4, further including a cap disposed over said second end of said first and second shafts, and could dated for allowing a user to apply downward pressure on said cutter against said encapsulated packaging.

6. The cutter of claim 2, further including first and second handles coupled to said second end of said first and second shafts respectively, said first and second handles configured for causing movement of said first and second shafts and said first and second cutter blades toward one another.

7. The cutter of claim 2, further including an access opening disposed in at least one of said first and second shafts, for allowing annexed is to objects or material trapped by said first and second cutter blades and said first and second shafts.

8. The cutter of claim 2, further including a locking device, said locking device configured for maintaining said first and second shafts and said first and second cutter blades in a closed position.

9. The cutter of claim 8, wherein said locking device includes a locking pin configured to be inserted through a first hole in said first shaft and continuing through a second hole in said second shaft, for maintaining said first and second shafts and said first and second cutter blades and a closed position.

10. The cutter of claim 1, further including an encapsulated device capturing device disposed proximate said at least one cutter blade, for generally receiving and holding said encapsulated object released from said encapsulated packaging.

11. The cutter of claim 1, wherein said at least one cutter blade includes a shape selected from the group consisting of straight, round, half-round, elliptical and V-shape.

12. The cutter of claim 1, wherein said at least one cutter blade includes two generally identical cutter blades configured for movement toward and away from one another.

13. The cutter of claim 1, wherein said at least one cutter blade includes a plurality of concentric cutter blades, said plurality of concentric cutter blades configured for moving inwardly and outwardly toward and a way from a central point.

14. A cutter for removing an object from an encapsulated packaging, said encapsulated packaging having a generally flat, planar surface, said encapsulated object protruding upwardly from said generally flat, planar surface and enclosed in an encapsulated packaging cavity having a base region and a top region, said cutter comprising:
first and second cutter blades, said first and second cutter blades operatively coupled to first and second shafts respectively, said first and second shafts having a first end proximate said respective first or second cutter blade and a second end remote from said cutter blade, said first and second shafts pivotably connected proximate their respective second ends, said first and second shafts configured for movement which advances said first and second cutter blades toward one another, said first and second cutter blades configured to be placed generally against and parallel to said generally flat, planar surface of said encapsulated packaging, and further configured to be advanced against and proximate first and second sides respectively of a base region of said encapsulated packaging cavity and advanced further through said base region, for cutting generally through said encapsulated packaging cavity thereby releasing said encapsulated object from said encapsulated packaging.
